(19) United States
(12) Patent Application Publication
(10) Pub. No.: US 2021/0270213 A1
(43) Pub. Date: Sep. 2, 2021

(54) Leakage Diagnosis Device for Fuel Vapor Processing Apparatus

(71) Applicant: AISAN KOGYO KABUSHIKI KAISHA, Obu-shi (JP)

(72) Inventors: Naohito BUSEKI, Obu-shi (JP); Masanobu SHINAGAWA, Nagoya-shi (JP)

(73) Assignee: AISAN KOGYO KABUSHIKI KAISHA, Obu-shi (JP)

(21) Appl. No.: 17/180,849

(22) Filed: Feb. 21, 2021

(30) Foreign Application Priority Data
Feb. 28, 2020 (JP) 2020-032896

(51) Int. Cl. F02M 25/08; G01M 3/02; G01M 3/26

(52) U.S. Cl. CPC F02M 25/0818; F02M 25/0836; F02M 2200/247; G01M 3/26; G01M 3/025

(57) ABSTRACT

A leakage diagnosis device is configured to detect leakage from a fuel vapor processing apparatus based on the internal pressure thereof. The fuel vapor processing apparatus includes a fuel tank and a canister in fluid communication with each other via a vapor passage. The leakage diagnosis device includes a negative pressure generator configured to generate a negative pressure therein to move gas from the canister to the fuel tank via a bypass passage. The vapor passage has an electrically controlled closing valve and a first mechanical check valve that are arranged in parallel. The first mechanical check valve is configured to be opened without electrical control to allow the fluid flow from the fuel tank to the canister. The bypass passage has a second mechanical check valve configured to be opened without electrical control to allow the fluid flow from the canister to the fuel tank.

### CROSS-REFERENCE TO RELATED APPLICATIONS

This application claims priority to Japanese patent application serial number 2020-032896, filed Feb. 28, 2020, which is hereby incorporated herein by reference in its entirety for all purposes.

### STATEMENT REGARDING FEDERALLY SPONSORED RESEARCH OR DEVELOPMENT

Not applicable.

### BACKGROUND

This disclosure relates generally to leakage diagnosis devices for fuel vapor processing apparatuses.

One type of vehicle using liquid fuel, such as gasoline, includes a fuel vapor processing apparatus for preventing fuel vapor from being released into the atmosphere. The fuel vapor processing apparatus can also reduce the likelihood of breakage of a fuel tank in response to an excessive increase or decrease of the internal pressure of the fuel tank. However, when the fuel vapor processing apparatus has a crack or a sealing failure, fuel vapor leaks from the internal space of the fuel vapor processing apparatus to the surrounding atmosphere. A driver of the vehicle cannot directly recognize such an undesired leakage of the fuel vapor. Thus, the fuel vapor processing apparatus is often equipped with one type of leakage diagnosis device.

### SUMMARY

In one aspect of this disclosure, a leakage diagnosis device is configured to detect leakage from a fuel vapor processing apparatus based on the internal pressure thereof. The fuel vapor processing apparatus includes a fuel tank, a canister, a vapor passage connecting the fuel tank to the canister, a closing valve disposed along the vapor passage, a purge passage connecting the canister to an intake pipe of an engine, and a purge valve disposed along the purge passage. The leakage diagnosis device for the fuel vapor processing apparatus includes a bypass passage, a negative pressure generator, a pressure sensor, and a processor. The bypass passage connects the fuel tank to the canister and bypasses the closing valve. The negative pressure generator is disposed in the fuel tank and is connected to one end of the bypass passage. The negative pressure generator is configured to generate negative pressure therein so as to move gas from the canister to the fuel tank via the bypass passage. The pressure sensor is configured to detect a pressure in an internal space of the fuel vapor processing apparatus. The processor is configured to determine leakage from the internal space based on the pressure in the internal space and is configured to electrically control the closing valve to be opened and closed. The vapor passage includes a sub-passage bypassing the closing valve and a first mechanical check valve disposed along the sub-passage such that the closing valve and the first mechanical check valve are arranged in parallel. The first mechanical check valve is configured to be opened by fluid pressure without electrical control so as to allow a fluid flow from the fuel tank to the canister. The bypass passage includes a second mechanical check valve configured to be opened by fluid pressure without electrical control so as to allow a fluid flow from the canister to the fuel tank.

In accordance with this aspect, the second mechanical check valve opens when the internal pressure of the fuel tank excessively decreases so as to prevent damage of the fuel tank. Further, the second mechanical check valve opens when the negative pressure generator generates negative pressure in the fuel tank so as to allow the gas movement from the canister to the fuel tank. Thus, although a conventional leakage diagnosis device needs two valves for these features, the leakage diagnosis device of this aspect can use the second mechanical check valve only, instead of the two valves. Accordingly, the structure of the leakage diagnosis device can be simplified, so that its mountability on a vehicle can be improved, and the manufacturing cost thereof can be reduced.

In the other aspect of this disclosure, a leakage diagnosis device is configured to detect leakage from a fuel vapor processing apparatus based on the internal pressure thereof. The fuel vapor processing apparatus includes a fuel tank, a canister fluidly communicated with the fuel tank, a purge passage connecting the canister to an intake pipe of an engine, a purge valve disposed along the purge passage, an atmospheric passage fluidly communicating the canister to an external space of the fuel vapor processing apparatus, and a closing valve disposed along the atmospheric passage. The leakage diagnosis device for the fuel vapor processing apparatus includes a suction passage, a negative pressure generator, a pressure sensor, and a processor. The suction passage provides fluid communication between the fuel tank and the external space while bypassing the canister. The negative pressure generator is disposed in the fuel tank and is coupled to one end of the suction passage. The negative pressure generator is configured to generate negative pressure therein so as to move gas from the external space into the fuel tank via the suction passage. The pressure sensor is configured to detect a pressure in an internal space of the fuel vapor processing apparatus. The processor is configured to determine leakage from the internal space based on the pressure in the internal space and is configured to electrically control the closing valve to be opened and closed. The atmospheric passage includes a sub-passage bypassing the closing valve and a first mechanical check valve disposed along the sub-passage such that the closing valve and the first mechanical check valve are arranged in parallel. The first mechanical check valve is configured to be opened by fluid pressure without electrical control so as to allow a fluid flow from the canister to the external space. The suction passage includes a second mechanical check valve configured to be opened by fluid pressure without electrical control so as to allow a fluid flow from the external space to the fuel tank.

In accordance with this aspect, the second mechanical check valve is opened when the internal pressure of the fuel tank excessively decreases so as to prevent damage to the fuel tank. Further, the second mechanical check valve is opened when the negative pressure generator generates negative pressure in the fuel tank so as to allow the gas movement from the canister to the fuel tank. Thus, although a conventional leakage diagnosis device needs two valves for these features, the leakage diagnosis device of this aspect can use the second mechanical check valve only, instead of the two valves.

In addition, the closing valve is opened during refueling so as to allow the fluid flow from the canister to the external space. Further, the closing valve is closed together with the purge valve, the first mechanical check valve, and the second mechanical check valve so as to hermetically seal the internal space of the fuel vapor processing apparatus. Thus, although the conventional leakage diagnosis device needs two valves for these features, the leakage diagnosis device of this aspect can use the closing valve only, instead of the two valves. Accordingly, the structure of the leakage diagnosis device can be simplified, so that its mountability on a vehicle can be improved, and the manufacturing cost thereof can be reduced.

### BRIEF DESCRIPTION OF THE DRAWINGS

FIG. 1 is a schematic view of a first embodiment of a fuel vapor processing apparatus equipped with a leakage diagnosis device according to the principles described herein.

FIG. 2 is a cross-sectional view of the aspirator of the leakage diagnosis device of FIG. 1.

FIG. 3 is a graph illustrating an operating state of a fuel pump, an opening-closing state of a negative pressure relief valve, an internal pressure of a canister, and an internal pressure of a fuel tank during a leakage diagnosis of the leakage diagnosis device of FIG. 1.

FIG. 4 is a schematic view of a second embodiment of a fuel vapor processing apparatus equipped with a leakage diagnosis device according to the principles described herein.

### DETAILED DESCRIPTION

In general, a leakage diagnosis device for a fuel vapor processing apparatus is configured to detect a fuel vapor leakage depending on changes in an internal pressure of a fuel tank and/or a canister. For example, in Japanese Laid-Open Patent Publication No. 2010-265860, a leakage diagnosis device is configured to move gas from a canister to a fuel tank and to block fluid communication between the fuel tank and the canister when the internal pressure of the fuel tank becomes positive and the internal pressure of the canister becomes negative. Then, the leakage diagnosis device determines the fuel vapor leakage based on changes in the internal pressures of the fuel tank and the canister while blocking fluid communication between the fuel tank and the canister.

In Japanese Laid-Open Patent Publication No. 2010-265860, the fuel tank is in fluid communication with the canister via a first passage and a second passage arranged in parallel. The first passages is provided with a positive pressure relief valve, a negative pressure relief valve, and a closing valve, which are arranged in parallel. Each of the positive pressure relief valve and the negative pressure relief valve is comprised of a mechanical check valve configured to open when the internal pressure of the fuel tank increases or decreases excessively, so as to prevent breakage of the fuel tank. The closing valve is electrically operated to be open during refueling. The second passage has an end connected to an aspirator disposed in the fuel tank and is provided with an electrically powered shut-off valve. The shut-off valve is configured to open when the aspirator is operated to move gas from the canister into the fuel tank. In other words, the fuel tank is in fluid communication with the canister via four valves arranged in parallel. Thus, it is complicated to mount the fuel vapor processing apparatus having the leakage diagnosis device on a vehicle. Therefore, there has been a need for an improved leakage diagnosis device for a fuel vapor processing apparatus.

A first embodiment of this disclosure will be described with reference to the drawings. In the first embodiment, a fuel vapor processing apparatus 10 is configured to prevent leakage of fuel vapor generated in a fuel tank 20 of a vehicle, such as an automobile, into the surrounding atmosphere. Specifically, the fuel vapor processing apparatus 10 is configured to temporarily trap the fuel vapor in a canister 30 and then burn the fuel vapor in an internal combustion engine 12, also referred to as an engine. The fuel vapor processing apparatus 10 includes a leakage diagnosis device configured to determine whether the fuel vapor leaks from the internal space of the fuel vapor processing apparatus 10 into the surrounding atmosphere.

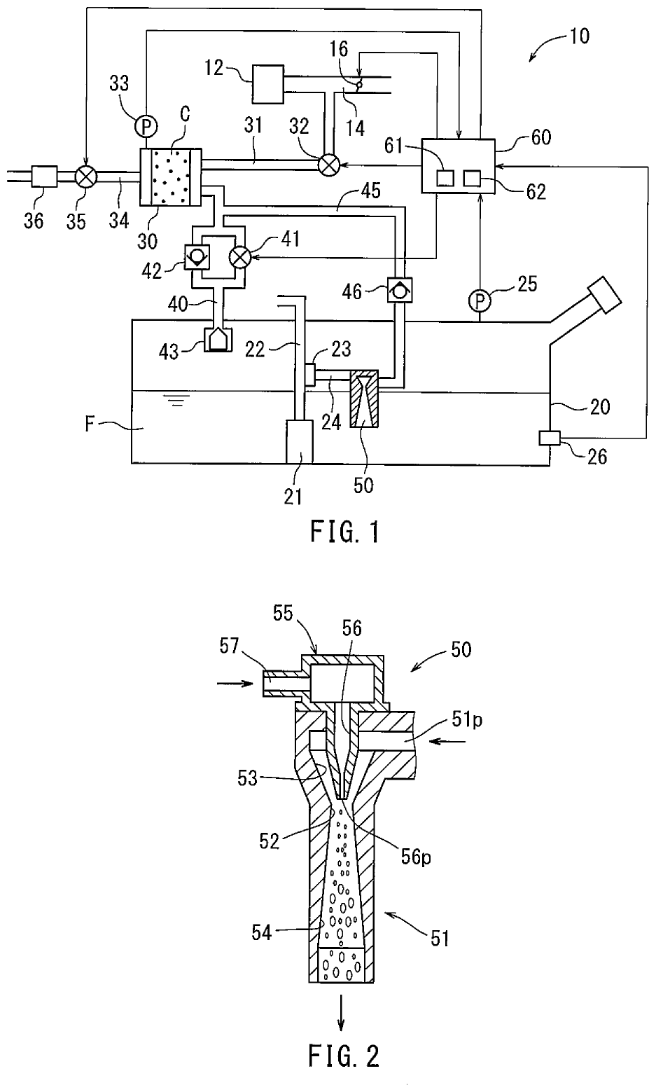

As shown in FIG. 1, the fuel vapor processing apparatus 10 includes the fuel tank 20 for storing liquid fuel therein, the canister 30 configured to adsorb and desorb the fuel vapor, and a vapor passage 40 fluidly coupling the fuel tank 20 to the canister 30.

The fuel tank 20 includes a sealed tank for storing liquid fuel F, such as gasoline. A fuel pump 21 disposed in the fuel tank 20 is configured to pump the fuel F to the engine 12. The fuel pump 21 may be an electric pump having an integral motor. The fuel pump 21 is connected to a fuel supply pipe 22, which supplies the fuel F stored in the fuel tank 20 to the engine 12.

A pressure regulator 23 is disposed along a middle portion of the fuel supply pipe 22. The pressure regulator 23 is connected to one end of a branch pipe 24 and is configured to discharge a portion of the fuel from the fuel supply pipe 22 into the branch pipe 24 when the internal pressure of the fuel supply pipe 22 is higher than a predetermined pressure. The other end of the branch pipe 24 is connected to an aspirator 50 such that the fuel discharged from the pressure regulator 23 into the branch pipe 24 is supplied to the aspirator 50. Accordingly, the aspirator 50 uses a portion of the fuel discharged from the fuel pump 21 into the fuel supply pipe 22 to generate negative pressure.

The fuel tank 20 includes a first pressure sensor 25 that detects and measures the internal pressure of the fuel tank 20, and a temperature sensor 26 that detects and measures the temperature of the fuel F in the fuel tank 20. Each of the first pressure sensor 25 and the temperature sensor 26 outputs signals representative of the measured pressures and temperatures, respectively, to an electronic control unit (ECU) 60. The ECU 60 is configured to control the fuel vapor processing apparatus 10 based on signals from various sensors including the first pressure sensor 25 and the temperature sensor 26. The ECU 60 includes a memory 61 for storing various control programs, and a processor 62 for executing the control programs.

The canister 30 includes a sealed container filled with an adsorbent C, such as an activated carbon. The canister 30 is in a fluid communication with the fuel tank 20 via the vapor passage 40 and is configured to adsorb the fuel vapor vaporized in the fuel tank 20. The canister 30 is connected to one end of a purge passage 31. The other end of the purge passage 31 is connected to an intake pipe 14 of the engine 12 downstream of a throttle valve 16. The purge passage 31 is provided with a purge valve 32 that is electrically controlled to be opened and closed by the ECU 60.

The canister 30 includes a second pressure sensor 33 configured to detect and measure the internal pressure of the canister 30 and to output signals representative of the measured pressures to the ECU 60.

The canister 30 is connected to an atmospheric passage 34. The atmospheric passage 34 has one end open to the atmosphere such that the canister 30 is in fluid communication with the outside via the atmospheric passage 34. An atmospheric passage valve 35 and an air filter 36 are arranged in series along the atmospheric passage 34 between the canister 30 and the open end of the atmospheric passage 34. The atmospheric passage valve 35 is electrically controlled so as to be opened and closed by the ECU 60. In this disclosure, the term “outside” generally corresponds to the environment and atmosphere external to the fuel vapor processing apparatus 10.

The vapor passage 40 provides fluid communication between the canister 30 and a gas space in the fuel tank 20, and more specifically, a space above the fuel level in the fuel tank 20. A middle portion of the vapor passage 40 is divided into two sub-passages arranged in parallel. A closing valve 41 is disposed along one of the sub-passages, and a positive pressure relief valve 42 is disposed along the other one of the sub-passages. That is, the vapor passage 40 includes the closing valve 41 and the positive pressure relief valve 42 arranged in parallel. The closing valve 41 is electrically controlled to be opened and closed by the ECU 60. The positive pressure relief valve 42 includes a mechanical check valve that opens in response to fluid pressure without electrical control. In particular, the positive pressure relief valve 42 is configured to open when the internal pressure of the vapor passage 40 between the fuel tank 20 and the positive pressure relief valve 42 is greater than the internal pressure of the vapor passage 40 between the canister 30 and the positive pressure relief valve 42 by a predetermined value. Thus, the positive pressure relief valve 42 allows the flow of fluid from the fuel tank 20 to the canister 30, and prevents the flow of fluid in the opposite direction. One end of the vapor passage 40 is located in the fuel tank 20 and is provided with a full tank control valve 43 having a float valve body. The full tank control valve 43 is open while the liquid level of the fuel F in the fuel tank 20 is lower than a full tank position. When the liquid level of the fuel F becomes higher than the full tank position, the float valve body floating near the liquid level moves upward to a valve closing position, thereby closing the full tank control valve 43. In this disclosure, the term “mechanical valve” generally corresponds to a valve configured to open and close without electrical control.

A bypass passage 45 is connected to the vapor passage 40 between the canister 30 and the divided sub-passages of the vapor passage 40. The other end of the bypass passage 45 is connected to the aspirator 50 disposed in the fuel tank 20. Thus, when the aspirator 50 generates negative pressure therein, gas in the canister 30 is introduced into the fuel tank 20 via the bypass passage 45. Alternatively, the end of the bypass passage 45 may be directly connected to the canister 30 instead of being connected to the vapor passage 40.

A negative pressure relief valve 46 is disposed along the bypass passage 45. The negative pressure relief valve 46 includes a mechanical check valve that opens in response to fluid pressure without electrical control. In particular, the negative pressure relief valve 46 is configured to open when the internal pressure of the bypass passage 45 between the canister 30 and the negative pressure relief valve 46 is greater than the internal pressure of the bypass passage 45 between the fuel tank 20 and the negative pressure relief valve 46 by a predetermined value. Thus, the negative pressure relief valve 46 allows the flow of fluid from the canister 30 to the fuel tank 20, and prevents the flow of fluid in the opposite direction.

The aspirator 50 utilizes the flow of the fuel discharged from the fuel pump 21 to generate negative pressure within the aspirator 50. As shown in FIG. 2, the aspirator 50 of this embodiment includes a venturi section or part 51 and a nozzle section or part 55 upstream of the venturi part 51. The venturi part 51 includes a diameter decreasing portion 53, a flow constriction 52, and a diameter expanding portion 54, which are coaxially arranged in series moving from the upstream end to the downstream end. The diameter decreasing portion 53 has a tapered shape with a diameter that gradually decreases moving toward the downstream end. The diameter of the diameter expanding portion 54 gradually increases moving toward the downstream side. A suction port 51p, which is connected to the bypass passage 45, is provided at an upstream end of the diameter decreasing portion 53 of the venturi part 51.

The nozzle part 55 includes a nozzle body 56 extending coaxially into the diameter decreasing portion 53 of the venturi part 51. A jet port 56p of the nozzle body 56 is positioned adjacent to the constriction 52 of the venturi part 51. A fuel supply port 57, which is connected to the branch pipe 24, is formed at the base of the nozzle body 56. The base of the nozzle body 56 is positioned opposite the jet port 56p.

A part of the fuel F discharged from the fuel pump 21 is introduced into the branch pipe 24 and is subsequently introduced into the aspirator 50 via the fuel supply port 57. That part of fuel F is jetted from the nozzle body 56, causing it to flow at a relatively high speed through centers of both the constriction 52 and the diameter expanding portion 54. Negative pressure is generated adjacent to the constriction 52 of the venturi part 51 due to the Venturi effect. As a result, gas in the bypass passage 45 is suctioned into the venturi part 51 via the suction port 51p.

Operations of the fuel vapor processing apparatus 10 will now be described. The fuel vapor processing apparatus 10 is controlled by the ECU 60 to prevent leakage of the fuel vapor evaporated in the fuel tank 20 into the atmosphere, depending on the condition of the vehicle.

While the vehicle is parked, the closing valve 41 of the vapor passage 40 is maintained in a closed state., the purge valve 32 of the purge passage 31 is maintained in a closed state, and the atmospheric passage valve 35 of the atmospheric passage 34 is maintained in an open state. In this state, the internal pressure of the fuel tank 20 is usually close to the atmospheric pressure such that the positive pressure relief valve 42 and the negative pressure relief valve 46 are closed. As a result, the fuel tank 20 is maintained in a sealingly closed state, thereby suppressing generation of fuel vapor therein.

While refueling the fuel tank 20, the closing valve 41 of the vapor passage 40 is opened. Further, the purge valve 32 of the purge passage 31 is maintained in the closed state, and the atmospheric passage valve 35 of the atmospheric passage 34 is maintained in the open state. Consequently, mixed gas in the fuel tank 20, which is composed of the fuel vapor and air, is introduced into the canister 30 via the vapor passage 40. Then, the fuel vapor in the mixed gas is adsorbed on the adsorbent C in the canister 30, while the air is released into the atmosphere via the atmospheric passage 34.

While the engine 12 is running, the closing valve 41 of the vapor passage 40 is maintained in the closed state. The internal pressure of the fuel tank 20 is usually close to the atmospheric pressure, so that the positive pressure relief valve 42 and the negative pressure relief valve 46 are maintained in the closed state. As a result, the fuel tank 20 is maintained in a sealed and closed state. When the predetermined purge conditions are met during the running of the engine 12, a purge operation is carried out to purge the fuel vapor from the canister 30. When the purge valve 32 is opened on the basis of signals output from the ECU 60, air flows into the canister 30 via the atmospheric passage 34 due to the negative pressure in the engine 12. The fuel vapor in the canister 30 is desorbed from the adsorbent C by the introduced air. The mixed gas including the fuel vapor and the air is then supplied to the engine 12 via the purge passage 31.

As described above, while the vehicle is parked or while the engine 12 is running, the closing valve 41, the positive pressure relief valve 42, and the negative pressure relief valve 46 are usually closed to block fluid communication between the fuel tank 20 and the canister 30. When the internal pressure of the fuel tank 20 sufficiently increases (e.g., higher than 10 kPa) such that the internal pressure of the vapor passage 40 on the fuel tank 20 side is greater than the internal pressure of the vapor passage 40 on the canister 30 side, i.e. the atmospheric pressure, by the predetermined value, the positive pressure relief valve 42 is opened. Consequently, the fuel tank 20 is in fluid communication with the canister 30, such that gas in the fuel tank 20 flows into the canister 30 via the vapor passage 40. In contrast, when the internal pressure of the fuel tank 20 sufficiently decreases (e.g., less than −10 kPa), in a state where the fluid communication between the fuel tank 20 and the canister 30 is blocked, such that the internal pressure of the bypass passage 45 on the canister 30 side is greater than the internal pressure of the bypass passage 45 on the fuel tank 20 side by the predetermined value, the negative pressure relief valve 46 is opened. As a result, the canister 30 is in fluid communication with the fuel tank 20 such that gas flows from the canister 30 into the fuel tank 20 via the bypass passage 45. Therefore, even if the internal pressure of the fuel tank 20 sufficiently increases or decreases, damage to the fuel tank can be prevented.

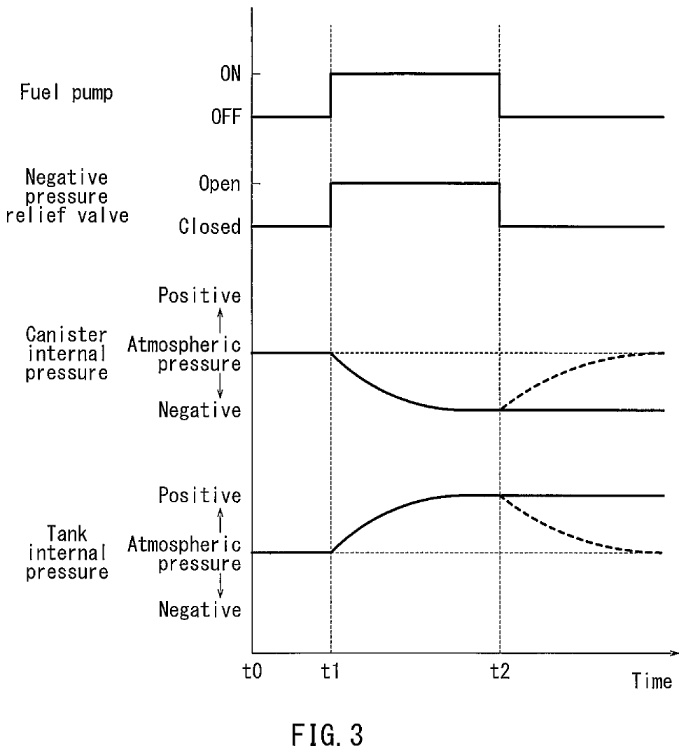

Next, leakage diagnosis, i.e. leakage detection, of the fuel vapor processing apparatus 10 will be described. On the right side of t2 on the horizontal axis in FIG. 3, each of the internal pressures of the fuel tank 20 and the canister 30 is drawn by a solid line in a case where there is no leakage, and is drawn by a dashed line in a case where there is leakage. In this embodiment, the ECU 60 controls components of the fuel vapor processing apparatus 10 on the basis of the control programs stored in the memory 61 to detect leakage depending on pressures detected by the first pressure sensor 25 and the second pressure sensor 33.

The leakage diagnosis of the fuel vapor processing apparatus 10 is performed on the basis of a pressure change in the internal space of the fuel vapor processing apparatus 10 while the engine 12 is stopped. Before starting the leakage diagnosis (t0 in FIG. 3), the purge valve 32 is closed.

When conditions for the leakage diagnosis are met while the vehicle is parked (t1), the atmospheric passage valve 35 is closed so as to hermetically seal the internal space of the fuel vapor processing apparatus 10. The internal space of the fuel vapor processing apparatus 10 is divided into a tank side region, including the fuel tank 20, and a canister side region, including the canister 30, by maintaining the closing valve 41, the positive pressure relief valve 42, and the negative pressure relief valve 46 in the closed state. In this state, the internal pressure of the canister 30 and the internal pressure of the fuel tank 20 are usually maintained close to the atmospheric pressure. Then, when the fuel pump 21 is driven, the aspirator 50 is operated to generate negative pressure therein. The negative pressure relief valve 46 is opened due to the negative pressure such that the fuel tank 20 is in fluid communication with the canister 30. Thus, gas in the canister 30 is moved into the fuel tank 20 via the bypass passage 45 and the negative pressure relief valve 46. As a result, as shown in FIG. 3, the internal pressure of the canister 30 gradually decreases, while the internal pressure of the fuel tank 20 gradually increases. After a predetermined period (t2), the fuel pump 21 is stopped such that the negative pressure relief valve 46 is closed. The internal pressure of the fuel tank 20 and the internal pressure of the canister 30 at this point (t2) are set such that the positive pressure relief valve 42 is maintained in the closed state.

Subsequently, the second pressure sensor 33 detects the internal pressure of the canister 30. When the predetermined period elapses, the pressure within the canister 30 is measured again. When the variation between these pressures is less than a predetermined reference value, the ECU 60 determines that there is no leakage, i.e. no hole, in the canister side region. In contrast, when the variation is greater than the predetermined reference value, the ECU 60 determines that there is leakage, i.e. hole(s) in the canister side region.

On the other hand, the internal pressure of the fuel tank 20 is measured by the first pressure sensor 25 at a time immediately after stopping the fuel pump 21 (t2) and at a time when the predetermined period elapses after stopping the fuel pump 21. When the variation between these pressures is less than a predetermine reference value, the ECU 60 determines that there is no leakage, i.e. no hole, in the tank side region. In contrast, when the variation is greater than the predetermined reference value, the ECU 60 determines that there is leakage, i.e. hole(s), in the tank side region.

The leakage diagnosis may be performed while the engine is running. Further, the timing when the diagnosis of the tank side region is performed may be different from the timing when the diagnosis of the canister side region is performed.

In this embodiment, gas flows from the canister 30 to the fuel tank 20 in a state where the internal space of the fuel vapor processing apparatus 10 is in a sealingly closed state such that the internal pressure of the canister 30 becomes negative and the internal pressure of the fuel tank 20 becomes positive at the same time. However, the aspirator 50 may be operated in a state where the purge valve 32 is closed and where the atmospheric passage valve 35 is open such that air is introduced into the fuel tank 20 via the atmospheric passage 34 and the bypass passage 45, thereby increasing the internal pressure of the fuel tank 20 so as to be positive. Subsequently, when the positive pressure within the fuel tank 20 increases to the predetermined value, the atmospheric passage valve 35 may be closed and the aspirator 50 may be continuously operated, thereby decreasing the internal pressure of the canister 30 so as to be negative.

In accordance with the first embodiment, when the internal pressure of the fuel tank 20 sufficiently decreases, the negative pressure relief valve 46 disposed along the bypass passage 45 is opened to allow the gas flow from the canister 30 to the fuel tank 20, thereby preventing damage to the fuel tank 20. Further, while the aspirator 50 is operated, the negative pressure relief valve 46 is opened to allow the flow of fluid from the canister 30 to the fuel tank 20. Thus, in comparison with the leakage diagnosis device of Japanese Laid-Open Patent Publication No. 2010-265860, the number of negative pressure relief valves can be reduced, and the structure of the leakage diagnosis device can be simplified. Accordingly, its mountability on a vehicle can be improved, and the manufacturing cost can be decreased.

In addition, the number of the valves can be decreased in comparison with the conventional leakage diagnosis device, it is able to reduce failures of diagnosis caused by a valve problem, such as sticking.

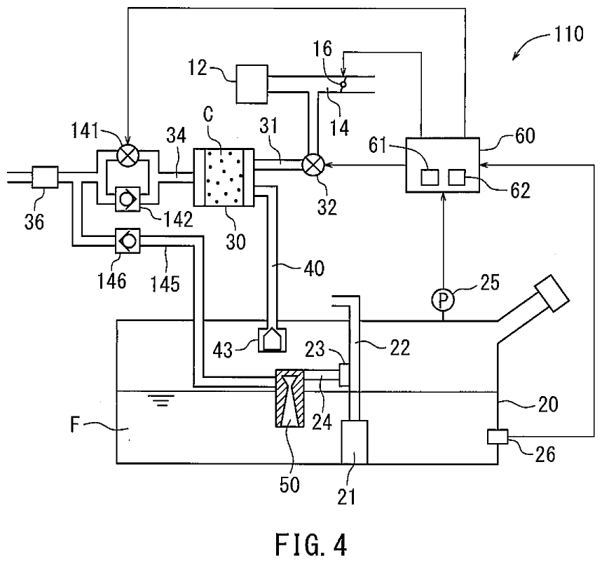

Next, a second embodiment of this disclosure will be described in connection with FIG. 4. The second embodiment corresponds to the first embodiment with some changes. Thus, the changes will be described, and the same or similar configurations will not be described.

As shown in FIG. 4, in a case of a fuel vapor processing apparatus 110 according to the second embodiment, the vapor passage 40 is not branched between the fuel tank 20 and the canister 30 and has no valve between the fuel tank 20 and the canister 30. Thus, in the normal state, the fuel tank 20 is always in fluid communication with the canister 30 via the vapor passage 40 such that the internal pressure of the fuel tank 20 is equal to or substantially equal to the internal pressure of the canister 30. Accordingly, the fuel vapor processing apparatus 110 includes only the first pressure sensor 25 configured to detect the internal pressure of the fuel tank 20 and does not include a pressure sensor configured to detect the internal pressure of the canister 30. Because the fuel vapor processing apparatus 110 needs to detect either the internal pressure of the fuel tank 20 or that of the canister 30, the fuel vapor processing apparatus 110 may alternatively include a pressure sensor configured to detect the internal pressure of the canister 30 instead of the first pressure sensor 25.

As shown in FIG. 4, a middle part of the atmospheric passage 34 between the canister 30 and the air filter 36 is divided into two sub-passages arranged in parallel. A closing valve 141 is disposed along one of the sub-passages and a positive pressure relief valve 142 is disposed along the other of the sub-passages. That is, the atmospheric passage 34 includes the closing valve 141 and the positive pressure relief valve 142 arranged in parallel. The closing valve 141 is electrically controlled to be opened and closed by the ECU 60. The positive pressure relief valve 142 includes a mechanical check valve, which is directly opened in response to fluid pressure without electrical control. In particular, the positive pressure relief valve 142 is configured to be opened when the pressure in the atmospheric passage 34 on the canister 30 side, i.e. the internal pressure of the atmospheric passage 34 between the canister 30 and the positive pressure relief valve 142, is greater than the pressure in the atmospheric passage 34 on the outside, i.e. the internal pressure of the atmospheric passage 34 between the air filter 36 and the positive pressure relief valve 142, by a predetermined value. Thus, the positive pressure relief valve 142 may allow the flow of fluid from the canister 30 to the outside and prevent the fluid flow in the opposite direction.

A suction passage 145 is connected to the atmospheric passage 34 at a position between the air filter 36 and the sub-passages of the atmospheric passage 34. The other end of the suction passage 145 is connected to the aspirator 50, and more particularly, to the suction port 51p (not shown in FIG. 4) in the fuel tank 20. Due to this configuration, the fuel tank 20 is in fluid communication with the external space of the fuel vapor processing apparatus 110 via the suction passage 145. Thus, when the aspirator 50 generates negative pressure therein, atmospheric air is introduced from the outside into the fuel tank 20 via the suction passage 145.

A negative pressure relief valve 146 is disposed along the suction passage 145. The negative pressure relief valve 146 includes a mechanical check valve, which is configured to be directly opened in response to fluid pressure without electrical control. In particular, the negative pressure relief valve 146 is configured to be opened when the pressure in the suction passage 145 on the outside, i.e. the internal pressure of the suction passage 145 between the air filter 36 and the negative pressure relief valve 146, is greater than the pressure in the suction passage 145 on the fuel tank 20 side, i.e. the internal pressure of the suction passage 145 between the fuel tank 20 and the negative pressure relief valve 146, by a predetermined value. Thus, the negative pressure relief valve 146 may allow the flow of fluid from the outside to the fuel tank 20 and prevent the fluid flow in the opposite direction.

Operation of the fuel vapor processing apparatus 110 will now be described. While the vehicle is parked, the purge valve 32 of the purge passage 31 and the closing valve 141 of the atmospheric passage 34 are held in the closed state. Because the internal pressure of the fuel tank 20 is normally closed to the atmospheric pressure, the positive pressure relief valve 142 and the negative pressure relief valve 146 are held in the closed state. Accordingly, the internal space of the fuel vapor processing apparatus 110 including the fuel tank 20 is kept in the sealingly closed state, so that generation of the fuel vapor in the fuel vapor processing apparatus 110 is suppressed.

During refueling of the fuel tank 20, the closing valve 141 of the atmospheric passage 34 is opened, and the purge valve 32 of the purge passage 31 is held in the closed state. Thus, the mixed gas, containing the fuel vapor and the air, flows from the fuel tank 20 to the canister 30 via the vapor passage 40. The fuel vapor in the mixed gas is adsorbed on the adsorbent C in the canister 30, while the air in the mixed gas is released to the outside via the atmospheric passage 34.

While the engine 12 is running, the purge valve 32 of the purge passage 31 and the closing valve 141 of the atmospheric passage 34 are kept in the closed state. Because the internal pressure of the fuel tank 20 is normally closed to the atmospheric pressure, the positive pressure relief valve 142 and the negative pressure relief valve 146 are held in the closed state. Thus, the internal space of the fuel vapor processing apparatus 110 is kept in the hermetically sealed state. When the predetermined purge conditions are met during the running of the engine 12, the purge operation is performed for purging the fuel vapor from the canister 30. When the purge valve 32 and the closing valve 141 are opened on the basis of signals output from the ECU 60, the air is introduced into the canister 30 through the atmospheric passage 34 in response to the negative pressure in the engine 12. The fuel vapor in the canister 30 is desorbed from the adsorbent C by the introduced air. Subsequently, the mixed gas, containing the fuel vapor and the air, is supplied to the engine 12 via the purge passage 31.

As described above, during the parking of the vehicle or the running of the engine 12, the purge valve 32, the closing valve 141, the positive pressure relief valve 142, and the negative pressure relief valve 146 are normally closed, so as to hermetically seal the internal space of the fuel vapor processing apparatus 110 including both the fuel tank 20 and the canister 30. In this state, when the pressure of the internal space of the fuel vapor processing apparatus 110 is greater than a predetermined pressure value (e.g., 10 kPa) such that the pressure in the atmospheric passage 34 on the canister 30 side is greater than the pressure in the atmospheric passage 34 on the outside by the predetermined value, the positive pressure relief valve 142 is opened. This allows the fluid communication between the canister 30 and the outside so that the gas in the fuel vapor processing apparatus 110 is discharged to the outside via the atmospheric passage 34. In contrast, when the pressure of the internal space of the fuel vapor processing apparatus 110 is less than a predetermined pressure value (e.g., −10 kPa) in a state where the internal space of the fuel vapor processing apparatus 110 is sealed, such that the pressure in the suction passage 145 on the outside is greater than the pressure in the suction passage 145 on the fuel tank 20 side by the predetermined value, the negative pressure relief valve 146 is opened. This allows the fluid communication between the fuel tank 20 and the outside such that the air is introduced from the outside into the fuel tank 20 via the suction passage 145. As a result, an excessive increase or decrease in the internal pressure of the fuel vapor processing apparatus 110 including the fuel tank 20 is suppressed, thereby preventing damage of the fuel tank 20, etc.

A leakage diagnosis, also referred to as “leakage detection” herein, of the fuel vapor processing apparatus 110 will now be described. The leakage diagnosis of the fuel vapor processing apparatus 110 is based on the pressure change in the internal space of the fuel vapor processing apparatus 110 while the engine 12 is stopped. Before the leakage diagnosis, the purge valve 32, the closing valve 141, the positive pressure relief valve 142, and the negative pressure relief valve 146 are closed so as to hermetically seal the internal space of the fuel vapor processing apparatus 110. In this state, the pressure of the internal space of the fuel vapor processing apparatus 110 is normally kept closed to the atmospheric pressure.

When some conditions for the leakage diagnosis are met during the parking of the vehicle, the fuel pump 21 is driven to operate the aspirator 50. When the aspirator 50 generates negative pressure therein, the negative pressure relief valve 146 is opens in response to the negative pressure thereby allowing fluid communication between the fuel tank 20 and the outside. Thus, the atmospheric air is introduced from the external space into the fuel tank 20 via the suction passage 145 and the negative pressure relief valve 146. Because the canister 30 is in fluid communication with the fuel tank 20 via the vapor passage 40, a part of the air introduced into the fuel tank 20 flows into the canister 30. Accordingly, the pressure in the fuel vapor processing apparatus 110 gradually increases. After a lapse of a predetermined period of time, the fuel pump 21 is stopped, so that the negative pressure relief valve 146 is closed. The internal pressure of the fuel tank 20 is set within a predetermined range where the positive pressure relief valve 142 is held in the closed state during this process.

Subsequently, the first pressure sensor 25 measures the internal pressure of the fuel tank 20. After a lapse of a predetermined period time, the first pressure sensor 25 measures the internal pressure of the fuel tank 20 again. When the variation of the internal pressure is less than a predetermined reference value, the ECU 60 determines that the fuel vapor processing apparatus 110 has no leakage from the internal space thereof, i.e. no hole. In contrast, when the variation of the internal pressure is greater than the predetermined reference value, the fuel vapor processing apparatus 110 has leakage from the internal space thereof, i.e. hole(s).

In accordance with the second embodiment, when the internal pressure of the fuel vapor processing apparatus 110 including the fuel tank 20 sufficiently decreases, the negative pressure relief valve 146 disposed along the suction passage 145 is opened such that the atmospheric air is introduced from the outside into the fuel tank 20, thereby preventing damage of the fuel tank 20, etc. Further, when the aspirator 50 is operated, the negative pressure relief valve 146 is opened so as to allow the fluid flow from the outside to the fuel tank 20. Accordingly, although a conventional leakage diagnosis device of a fuel vapor processing apparatus needs two valves for respective roles, the present embodiment can use the negative pressure relief valve 146 only, instead of the two valves. This can simplify the structure of the apparatus such that its mountability on the vehicle can be improved and the manufacturing cost reduced.

The closing valve 141 is configured to allow the flow of the fuel vapor from the fuel tank 20 to the outside via the canister 30 during refueling and is configured to be closed together with the purge valve 32, the positive pressure relief valve 142, and the negative pressure relief valve 146 so as to hermetically seal the internal space of the fuel vapor processing apparatus 110 during the leakage diagnosis. Thus, although the conventional leakage diagnosis device of the fuel vapor processing apparatus needs two valves for these two functions, the present embodiment can use the closing valve 141 only, instead of the two valves. Accordingly, the number of valves can be further reduced, so that the structure of the apparatus can be simplified. This can improve the mountability of the apparatus on the vehicle and reduce the manufacturing cost of the apparatus.

Further, the number of the valves can be reduced in comparison with the conventional leakage diagnosis device, the diagnosis failure caused by a trouble of the valves may be reduced.

The technology disclosed herein is not limited to the above-described embodiments. For example, the aspirator 50 can be replaced with a pump unit that is configured to generate negative pressure therein for moving gas from the canister 30 or the outside into the fuel tank 20. The leakage diagnosis device can be combined with other fuel vapor processing apparatuses (e.g. one mounted on a ship).

Various modifications of the present disclosure can be carried out. In one aspect, a leakage diagnosis device for a fuel vapor processing apparatus is configured to perform a leakage diagnosis depending on a pressure of an internal space of the fuel vapor processing apparatus. The fuel vapor processing apparatus includes a fuel tank and a canister, which are in communication with each other via a communication passage. The leakage diagnosis device includes a sealing system configured to maintain the internal space in a sealed state, a shutoff system configured to block fluid communication between the fuel tank and the canister, a pressure sensor configured to detect an internal pressure of the canister and an internal pressure of the fuel tank, and a negative pressure generator disposed in the fuel tank and configured to generate negative pressure so as to move gas from the canister to the fuel tank via the communication passage. The shutoff system is disposed along the communication passage and includes a mechanical check valve allowing a fluid flow from the canister to the fuel tank. When the internal pressure of the fuel tank is less than a predetermined value in a state where the fluid communication between the fuel tank and the canister is blocked, the check valve is opened, so as to allow the fluid communication between the fuel tank and the canister. When the negative pressure generator generates negative pressure, the check valve is opened by the negative pressure, so as to allow the fluid communication between the fuel tank and the canister. In this aspect, the vapor passage 40 and the bypass passage 45 of the first embodiment may be referred to as the “communication passage.” The purge valve 32 and the atmospheric passage valve 35 may be referred to as the “sealing system.” The closing valve 41, the positive pressure relief valve 42, and the negative pressure relief valve 46 may be referred to as the “shutoff system.” The negative pressure relief valve 46 may be also referred to as the “check valve.”

What is claimed is:

1. A leakage diagnosis device for a fuel vapor processing apparatus, the fuel vapor processing apparatus including a fuel tank, a canister, a vapor passage connecting the fuel tank to the canister, a closing valve disposed along the vapor passage, a purge passage connecting the canister to an intake pipe of an engine, and a purge valve disposed along the purge passage, the leakage diagnosis device comprising:
a bypass passage connecting the fuel tank to the canister and bypassing the closing valve;
a negative pressure generator disposed in the fuel tank and connected to one end of the bypass passage, wherein the negative pressure generator is configured to generate a negative pressure therein so as to move a gas from the canister to the fuel tank via the bypass passage;
a pressure sensor configured to detect a pressure in an internal space of the fuel vapor processing apparatus; and
a processor configured to determine leakage from the internal space based on the pressure in the internal space and electrically control the closing valve to be opened and closed;
wherein:
the vapor passage includes a sub-passage bypassing the closing valve and a first mechanical check valve disposed along the sub-passage such that the closing valve and the first mechanical check valve are arranged in parallel;
the first mechanical check valve is configured to be opened by fluid pressure and without electrical control so as to allow fluid flow from the fuel tank to the canister; and
the bypass passage includes a second mechanical check valve configured to be opened by fluid pressure and without electrical control so as to allow a fluid flow from the canister to the fuel tank.

2. A leakage diagnosis device for a fuel vapor processing apparatus, the fuel vapor processing apparatus including a fuel tank, a canister in fluid communication with the fuel tank, a purge passage connecting the canister to an intake pipe of an engine, a purge valve disposed along the purge passage, an atmospheric passage fluidly coupling the canister to an external space of the fuel vapor processing apparatus, and a closing valve disposed along the atmospheric passage, the leakage diagnosis device comprising:
a suction passage fluidly coupling the fuel tank to the external space and bypassing the canister;
a negative pressure generator disposed in the fuel tank and connected to one end of the suction passage, wherein the negative pressure generator is configured to generate negative pressure therein so as to move a gas from the external space into the fuel tank via the suction passage;
a pressure sensor configured to detect a pressure in an internal space of the fuel vapor processing apparatus; and
a processor configured to determine leakage from the internal space based on the pressure in the internal space and electrically control the closing valve to be opened and closed;
wherein:
the atmospheric passage includes a sub-passage bypassing the closing valve and a first mechanical check valve disposed along the sub-passage such that the closing valve and the first mechanical check valve are arranged in parallel;
the first mechanical check valve is configured to be opened by fluid pressure and without electrical control so as to allow a fluid flow from the canister to the external space; and
the suction passage includes a second mechanical check valve configured to be opened by fluid pressure and without electrical control so as to allow a fluid flow from the external space to the fuel tank.
